(19) United States
(12) Patent Application Publication
(10) Pub. No.: US 2017/0346648 A1
(43) Pub. Date: Nov. 30, 2017

(54) GROUP COMMUNICATION SYSTEM AND GROUP COMMUNICATION METHOD

(71) Applicant: PEIKER CONSUMER ELECTRONICS EVOLUTION GMBH, Friedrichsdorf (DE)

(72) Inventors: Klaus FROEMEL, Bad Homburg (DE); Eugen HERLEIN, Stadtallendorf (DE)

(73) Assignee: PEIKER CONSUMER ELECTRONICS EVOLUTION GMBH, Friedrichsdorf (DE)

(21) Appl. No.: 15/621,297

(22) Filed: Jun. 13, 2017

Related U.S. Application Data
(63) Continuation of application No. PCT/EP2015/080232, filed on Dec. 17, 2015.

(30) Foreign Application Priority Data
Dec. 17, 2014 (DE) 10 2014 118 886.1

(51) Int. Cl. H04L 12/18

(52) U.S. Cl. CPC H04L 12/1822; H04L 12/189; H04L 12/1827; H04L 12/1818

(57) ABSTRACT

The present invention relates to a group communication system comprising three, four, five or six communication devices which communicate in a wireless network operating according to a short range radio standard; primarily voice communication between a group of people takes place via the wireless network, each person in the group of people carrying a communication device.

### CROSS REFERENCE TO RELATED APPLICATIONS

This application is a continuation of International Application No. PCT/EP2015/080232 filed Dec. 17, 2015, which designated the United States, and claims the benefit under 35 USC §119(a)-(d) of German Application No. 10 2014 118 886.1 filed Dec. 17, 2014, the entireties of which are incorporated herein by reference.

### FIELD OF THE INVENTION

The present invention relates to a group communication system, as well as a group communication method.

### BACKGROUND OF THE INVENTION

EP 1 755 325 A2 discloses a group communication system, which is used for carrying out phone conferences.

### SUMMARY OF THE INVENTION

It is an object of the present invention to propose a group communication system or a group communication method, which is suitable for communication within a group, which comprises one person with a teacher function and at least one person with a student function. Furthermore, it is an object of the present invention to handle the communication with technically simple means over a radio network, which operates according to a short-range radio standard.

The present invention relates to a group communication system, wherein the group communication system comprises at least two communication devices and, in particular, three or four or five or six communication devices, wherein the communication devices communicate in a radio network, wherein the radio network operates as a radio network according to the one standard for short-range radio, wherein predominantly speech communication is carried out over the radio network between a group of persons, wherein each person of the group carries a communication device. Here, a person of the group uses a teacher function of the communication device assigned to him/her, wherein all other persons of the group use a student function of the respectively assigned communication device, wherein the group communication system assumes one of at least three communication states for the group communication, depending on a selection made by the person with the teacher function and/or by at least one person with a student function, wherein the first communication state is configured in such a way that a moderator mode is active, in which the person with the teacher function speaks and all persons with a student function listen, wherein the second communication state is configured in such a way that a participant mode is active, in which the person with the teacher function is connected to a person with a student function by a full duplex connection and the other persons with a student function listens in and wherein the third communication state is configured in such a way, that a private mode is active, in which the person with the teacher function is connected with a person with a student function by a full duplex connection and the other persons with a student function are excluded from listening in. Such a group communication system makes it possible for the person with a teacher function to address the group or individual persons of the group in different ways, so that both group teaching and providing individual support is possible while at the same time, the group is monitored.

By using the Bluetooth standard for short-range radio, it is possible to operate the group communication device virtually anywhere in the world without violating country-specific regulations for the use of radio frequencies.

It is also provided, in electronic units of the communication devices, through deviation from the A2DP Bluetooth profile, which is also referred to as an advanced audio distribution profile, while avoiding a use of the AVDTP bluetooth profile, on which the A2DP bluetooth profile is based, and which is also referred to as an audio/video distribution transport protocol, to establish a direct data connection between the communication devices, wherein the necessary transmission parameters in the electronics units of the communication devices are hardwired in such a way, that a prior negotiation between the electronic units of the communication devices is avoided. This allows the necessary data connections to be established rapidly and error-free.

Furthermore, it is provided to establish the stream of audio data, referred to as the audio stream, between the communication devices so that said audio stream can be established between the communication device of the person with the teaching function and each communication device of a person with a student function selectively either in a first direction as a simplex audio stream or in a second direction as a simplex audio stream or as a full-duplex audio stream. By these means, the different types of communication in the group can be realized simply and reliably.

It is also provided to additionally give the group communication system at least one of two further communication states for the group communication, depending on a selection made by the person with the teacher function and/or by at least one person with a student function, wherein the fourth communication state is configured in such a way that a monitoring mode is active, in which the person with the teacher function hears all persons with a student function and wherein the fifth communication state is configured in such a way that a private and monitoring mode is active, in which the person with the teacher function is connected with a person with a student function by a full duplex connection and the person with the teacher function hears the others with the student function. As a result, the communication requirements of a group can be addressed even more specifically with the group communication system.

It is further provided, that a fourth and/or fifth and/or sixth communication state can also be assumed by the group communication system in addition to or as an alternative to a first and/or second and/or third communication state, wherein the fourth communication state is configured in such a way that is monitoring mode is active, in which the person with the teacher function hears all persons with a student function, wherein the fifth communication state is configured in such a way that a private and monitoring mode is active, in which the person with the teacher function is connected with a person with a student function by a full duplex connection and the person with the teacher function hears the others with the student function, and wherein the sixth communication state is configured in such a way that a private and monitoring mode is active, in which the person with the teacher function is connected with more than one person with a student function by a full duplex connection and the person with the teacher function hears the remaining persons with the student function or is heard by the remaining persons with the student function. As a result, the communication requirements of a group can be addressed likewise particularly specifically with the group communication system.

The inventive group communication method, in which a group communication system is used and which comprises at least three communication devices, provides the steps named in the following, wherein one of the communication devices is referred to as the master device and forms a communication device of a person with a teacher function and wherein at least two further communication devices are referred to as slave devices and form the communication devices of a person with a student function, wherein a Bluetooth wireless network is used for the communication:
developing a logical Bluetooth connection between the master device and the slave devices in the form of point-to-point connections,
establishing a transmission of command data between the master device and the slave devices involved over asynchronous ACL channels,
establishing either the duplex transmission type or the simplex transmission type between the master device and the at least one slave device by means of command data, and
establishing an SBC-coded audio transmission over L2CAP channels. By these means, the construction and implementation of the communication can be simplified significantly and therefore also have a higher reliability and availability.

Finally, the group communication method provides an SBC-coded audio transmission over the L2CAP channels, while a packing of this data in frames of a real-time transport system (RTP frames) is avoided. This allows the audio data to be encoded with little delay.

### BRIEF DESCRIPTION OF THE DRAWINGS

Further details of the invention are described in the drawing by means of diagrammatically illustrated exemplary embodiments.

FIG. 1 shows a diagrammatic representation of a group communication system in the moderator mode;

FIG. 2 shows a diagrammatic representation of a group communication system in the participant mode; and

FIG. 3 shows a diagrammatic representation of a group communication system in the private mode.

### DETAILED DESCRIPTION OF THE INVENTION

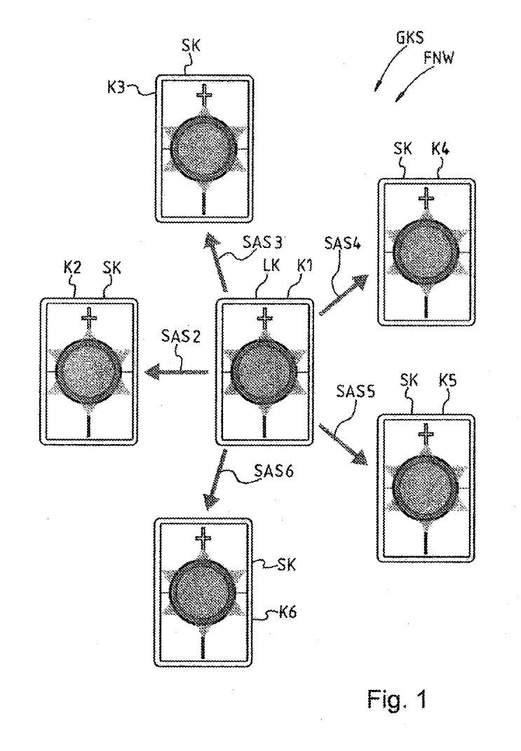

FIG. 1 symbolically shows six communication devices K1 to K6 in a radio network FNW, which together form a group communication system GKS. In this case, the communication device K1 is designed as a teacher communication device LK, which is assigned to one person with a teacher function. In this case, the communication devices K2 to K6 are designed as student communication devices SK, which are each assigned to a student. The simplex audio streams SAS2 to SASE emanating from the teacher communication device LK, are symbolized by the arrows, which point from the teacher communication device LK to the student communication devices SK. Correspondingly, the group communication system GKS is in a first communication state or a moderator mode, in which the person with the teacher function speaks and all persons with a student function listen.

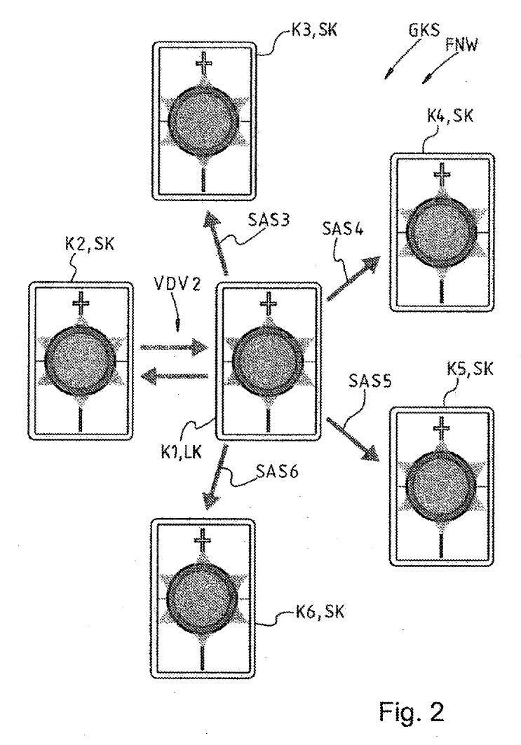

In FIG. 2, the six communication devices K1 to K6, which are known from FIG. 1, are again shown symbolically in the radio network FNW. These show the group communication system GKS in a second communication state, in which a participant mode is active, in which the person with the teacher function is connected with a person with a student function by a full duplex connection VDV2 and the other persons with a student function can again listen to the simplex audio streams SAS2 to SAS6 from the teacher communication device LK.

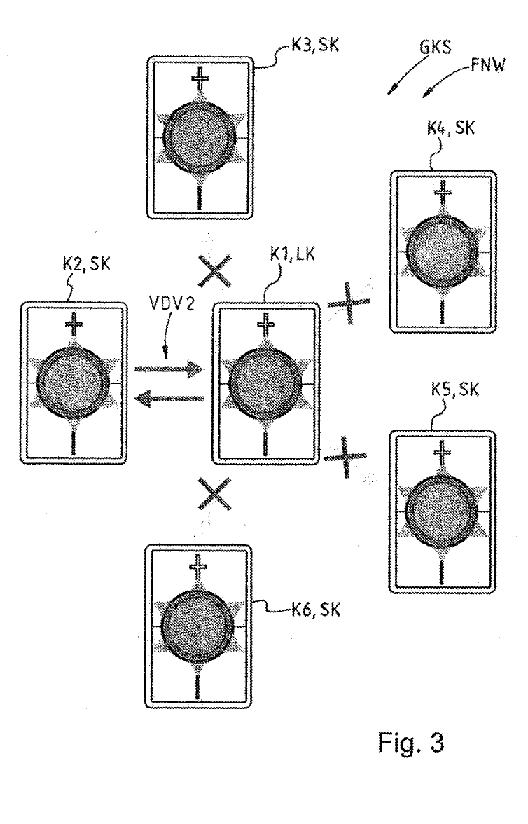

In FIG. 3, the six communication devices K1 to K6, which are known from FIG. 1, are once again shown symbolically in the radio network FNW. These show the group communication system GKS in a third communication state, in which a private mode is active, in which the person with the teacher function is connected to a person with a student function by a full duplex connection VDV2 and the other persons with a student function are excluded from communicating with the teacher communication device LK.

The group communication system is designed in such a way, that the transmission takes place via asynchronous ACL channels, with a point-to-point connection existing in each case between the teacher communication device functioning as master and the student communication devices functioning as slaves. This connection is used either as a duplex connection in both directions or as a simplex connection in only one direction. In the case of a duplex connection, there is a communication between the teacher communication device and one of the student communication devices. In the case of a simplex connection, the teacher communication device addresses one or more student communication devices. The audio data of the respective communication are SBC-coded and are transmitted over L2CAP channels.

Furthermore, in the group communication system, the message transmission (signaling) is extended, in order to be able to communicate pushbutton states and/or functional states from the teacher communication device LK to at least one of the student communication devices SK, for example. By these means, the respective function of the group communication system is then determined. By these means, different operating modes can be activated and/or deactivated by the teacher communication device LK and/or by the student communication device SK.

In particular, it is provided that the teacher communication device LK can control the student communication devices SK remotely and, for example, the audio function of a single student communication device SK can be activated by means of the teacher communication device LK.

To increase the security and protect the private sphere, it is envisaged in accordance with one variation of the embodiment to establish and operate session-based connections exclusively.

### LIST OF REFERENCE SYMBOLS

FNW radio network
GKS group communication system
K1 communication device
K2-K6 communication device
LK teacher communication device
SAS2-SAS6 simplex audio stream
SK student communication device
VDV2 full duplex connection

1. A group communication system comprising:
three, four, five or six communication devices,
wherein the communication devices communicate in a radio network,
wherein the radio network operates as a radio network according to a standard for short-range radio,
wherein predominantly speech communication is carried out over the radio network between a group of persons,
wherein each person of the group carries a communication device,
wherein a person of the group uses a teacher function of the communication device assigned to him/her,
wherein all other persons of the group use a student function of the respectively assigned communication device,
wherein the group communication system assumes one of at least three communication states for the group communication, depending on a selection made by the person with the teacher function and/or by at least one person with a student function,
wherein the first communication state is configured in such a way that a moderator mode is active, in which the person with the teacher function speaks and all persons with a student function listen,
wherein the second communication state is configured in such a way that a participant mode is active, in which the person with the teacher function is connected to a person with a student function by a full duplex connection and the other persons with a student function listen in, and
wherein the third communication state is designed so that a private mode is active, in which the person with the teacher function is connected with a person with the student function by a full duplex connection and the other persons with a student function are excluded from listening in.

2. The group communication system as claimed in claim 1, wherein the standard for the short-range radio is the Bluetooth standard.

3. The group communication system as claimed in claim wherein, in electronic units of the communication devices, through deviation from the A2DP Bluetooth profile, which is also referred to as an advanced audio distribution profile, while avoiding a use of the AVDTP bluetooth profile, on which the A2DP bluetooth profile is based, and which is also referred to as an audio/video distribution transport protocol, a direct data connection is established between the communication devices, wherein the necessary transmission parameters in the electronics units of the communication devices are hardwired in such a way that a prior negotiation of the data connection between the electronic units of the communication devices is avoided.

4. The group communication system as claimed in claim 1, wherein the audio stream between the communication devices is established so that said audio stream can be established between the communication device of the person with the teacher function and each communication device of a person with a student function either in a first direction as a simplex audio stream or in a second direction as a simplex audio stream or as a full-duplex audio stream.

5. The group communication system as claimed in claim 1, wherein the group communication system additionally assumes at least one of two further communication states for the group communication, depending on a selection made by the person with the teacher function and/or by at least one person with a student function,
wherein the fourth communication state is configured in such a way that a monitoring mode is active, in which the person with the teacher function hears all persons with a student function,
wherein the fifth communication state is configured in such a way that a private and monitoring mode is active, in which the person with the teacher function is connected with a person with a student function by a full duplex connection and the person with the teacher function hears the others with the student function.

6. The group communication system as claimed in claim 1, wherein a fourth and/or fifth and/or sixth communication state can also be assumed by the group communication system in addition to or as an alternative to a first and/or second and/or third communication state,
wherein the fourth communication state is configured in such a way that a monitoring mode is active, in which the person with the teacher function hears all persons with a student function,
wherein the fifth communication state is configured in such a way that a private and monitoring mode is active, in which the person with the teacher function is connected with a person with a student function by a full duplex connection and the person with the teacher function hears the others with the student function, and
wherein the sixth communication state is configured in such a way that a private and monitoring mode is active, in which the person with the teacher function is connected with more than one person with a student function by a full duplex connection and the person with the teacher function hears the remaining persons with the student function or is heard by the remaining persons with the student function.

7. A group communication method comprising a group communication system, as claimed in claim 1,
wherein the group communication system comprises at least three communication devices,
wherein one of the communication devices is referred to as the master device and forms a communication device of a person with a teacher function and wherein at least two further communication devices are referred to as slave devices and form the communication devices of persons with a student function,
wherein a Bluetooth radio network is used for the communication,
comprising the steps:
developing a logical Bluetooth connection between the master device and the slave devices in the form of point-to-point connections,
establishing a transmission of command data between the master device and the slave devices involved over asynchronous ACL channels,
establishing either the duplex transmission type or the simplex transmission type between the master device and the at least one slave device by means of command data,
establishing an SBC-coded audio transmission over L2CAP channels.

8. The group communication method as claimed in claim 7, wherein the SBC-coded audio transmission is carried out over the L2CAP channels while a packing of this data in frames of a real-time transport system is avoided.
